(19) United States
(12) Patent Application Publication
(10) Pub. No.: US 2004/0108097 A1
(43) Pub. Date: Jun. 10, 2004

(54) Heat exchanger unit

(76) Inventor: Naoki Ueda, Kariya-city (JP)

Correspondence Address: HARNESS, DICKEY & PIERCE, P.L.C., P.O. BOX 828, BLOOMFIELD HILLS, MI, 48303, US

(21) Appl. No.: 10/649,037

(22) Filed: Aug. 27, 2003

(30) Foreign Application Priority Data
Aug. 29, 2002 (JP) 2002-250804

(51) Int. Cl. F28F 1/00; B61D 27/00; B60H 3/00; F01P 1/00

(52) U.S. Cl. 165/42; 165/41; 165/51

(57) ABSTRACT

A heat exchanger unit includes a first heat exchanger for flowing internal fluid therein and cooling the internal fluid, and a second heat exchanger disposed downstream of the internal fluid from the first heat exchanger. The first and second heat exchangers are made of first and second materials, respectively. The first material is different from the second material. Each material composing each heat exchanger can be selected individually according to each temperature of the internal fluid flowing into each heat exchanger. Therefore, the heat resistance of the heat exchanger unit is improved without increasing the manufacturing cost.

### CROSS REFERENCE TO RELATED APPLICATION

This application is based on Japanese Patent Application No. 2002-250804 filed on Aug. 29, 2002, the disclosure of which is incorporated herein by reference.

### FIELD OF THE INVENTION

The present invention relates to a heat exchanger unit having first and second heat exchangers. The heat exchanger unit is suitably used for a vehicle.

### BACKGROUND OF THE INVENTION

A heat exchanger unit according to a prior art is disclosed in Japanese Unexamined Utility Model Application Publication No. H03-51138. The heat exchanger unit is a two-piece heat exchanger, which includes the first and second intercoolers. The heat exchanger unit is disposed downstream from a turbo-charger mounted in an air-intake passage of an engine in a vehicle. The first and second intercoolers are integrated together. A supercharger and a bypass valve are disposed between the first and second intercoolers. When the engine runs at low or medium speed, the bypass valve is closed, and the turbo-charger supercharges the air for combusting in the engine. The supercharged air is cooled by the second intercooler, which is disposed upstream from the supercharger, so that the supercharger is protected from thermal damage.

However, in the above heat exchanger unit, there is no consideration in relation to heat resistance of the intercooler against the supercharged air. In some case, the temperature of the supercharged air is comparatively high, so that durability of the intercooler is decreased. If the heat resistance of the intercooler is improved so as to increase the durability, the manufacturing cost of the intercooler becomes high.

### SUMMARY OF THE INVENTION

In view of the above problem, it is an object of the present invention to provide a heat exchanger unit, which has high heat resistance without increasing the manufacturing cost.

A heat exchanger unit includes a first heat exchanger for flowing internal fluid therein and cooling the internal fluid, and a second heat exchanger disposed downstream of the internal fluid from the first heat exchanger. The first and second heat exchangers are made of first and second materials, respectively. The first material is different from the second material.

In this heat exchanger unit, each material composing each heat exchanger can be selected individually according to each temperature of the internal air flowing into each heat exchanger. Therefore, the heat resistance of the heat exchanger unit is improved without increasing the manufacturing cost of the heat exchanger unit.

Preferably, the internal fluid is cooled by the first and second heat exchangers in this order, and the first material is superior to the second material with regard to mechanical strength against high temperature. More preferably, the first material is copper or copper based material, and the second material is aluminum or aluminum based material. In this case, the tensile strength of the first heat exchanger becomes large so that the heat resistance of the first heat exchanger is improved. Here, the temperature of the first heat exchanger is higher than that of the second heat exchanger.

Preferably, the internal fluid is air for being supercharged and sucked into an engine of a vehicle, and the first and second heat exchangers are first and second intercoolers, respectively. In this case, the temperature of the internal fluid in the first heat exchanger is much higher than that in the second heat exchanger. Therefore, the heat exchanger unit is suitably used for the intercooler of the vehicle.

Preferably, the first and second heat exchangers are disposed in a direction of external fluid for passing therethrough and cooling the internal fluid. The first heat exchanger is disposed downstream of the external fluid from a radiator for cooling an engine of a vehicle, and disposed downstream of the external fluid from the second heat exchanger. More preferably, the second heat exchanger is disposed upstream of the external fluid from the radiator.

Preferably, the first and second heat exchangers are disposed in a direction of external fluid for passing therethrough and cooling the internal fluid, and the first heat exchanger is disposed upstream of the external fluid from the second heat exchanger. More preferably, the second heat exchanger is disposed upstream of the external fluid from a radiator for cooling an engine of a vehicle.

### BRIEF DESCRIPTION OF THE DRAWINGS

The above and other objects, features and advantages of the present invention will become more apparent from the following detailed description made with reference to the accompanying drawings. In the drawings:

FIG. 1 is a schematic cross-sectional view showing intercoolers and a radiator mounted on a vehicle, according to a first embodiment of the present invention;

FIG. 2 is a front view showing the intercooler, according to the first embodiment;

FIG. 3 is a graph showing a relationship between temperature and tensile strength of copper and aluminum; and

FIG. 4 is a schematic cross-sectional view showing intercoolers and a radiator mounted on the vehicle, according to a second embodiment of the present invention.

### DETAILED DESCRIPTION OF THE PREFERRED EMBODIMENT

(First Embodiment)

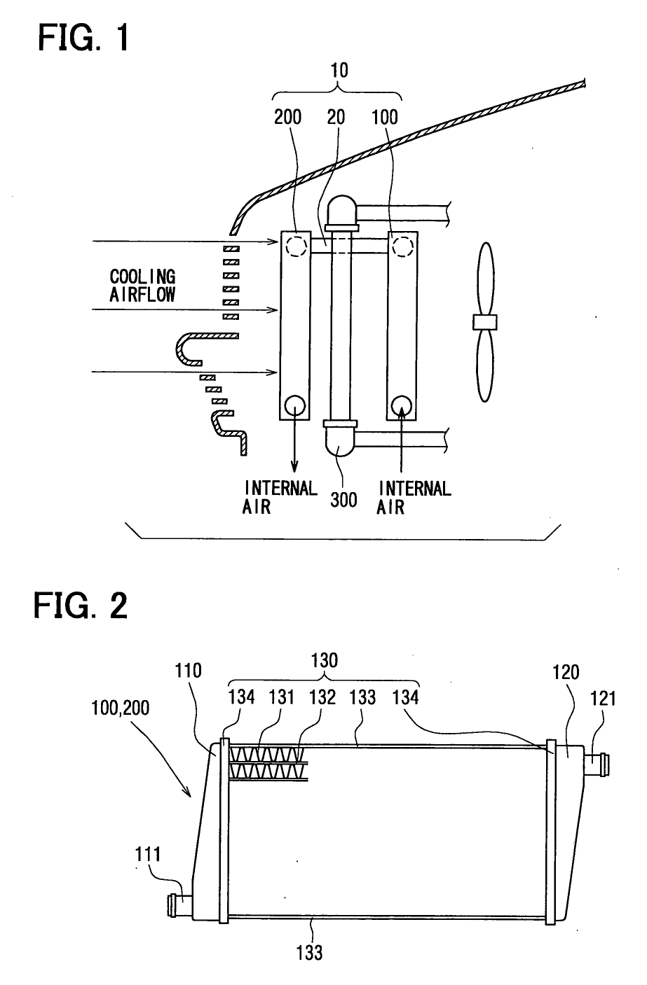

A heat exchanger unit according to a first embodiment of the present invention is shown in FIGS. 1-3. The heat exchanger unit is provided for an intercooler 10. The intercooler 10 cools the internal air, which is supercharged and heated so that the temperature of the internal air becomes high. Specifically, the internal air (i.e., the internal fluid) for combusting in an engine of a vehicle passes through the intercooler 10, so that the internal air is cooled by a cooling airflow (i.e., an external fluid) that passes outside the intercooler 10.

The intercooler 10 includes the first intercooler (i.e., the first heat exchanger) 100 and the second intercooler (i.e., the second heat exchanger) 200, which are connected with a hose 20. The internal air flowing in the intercooler 10 flows into the first intercooler 100 at first, and then flows out from the second intercooler 200, which is disposed downstream of the internal air from the first intercooler 100.

The first and second intercoolers 100, 200 are disposed in an engine compartment of the vehicle. The first intercooler 100 is disposed downstream of the cooling airflow from a radiator 300 for cooling the engine of the vehicle. The second intercooler 200 is disposed upstream of the cooling airflow from the radiator 300. The radiator 300 is an aluminum radiator, a radiator core 301 of which is made of aluminum or aluminum based material. The radiator core 301 is used as a heat exchange portion. The cooling airflow is provided by ram pressure in a case of the vehicle running or by a cooling fan (not shown) driven by the engine.

The first and second intercoolers 100, 200 and the radiator 300 are arranged so as to perform the following arrangement. If both the first and second intercoolers 100, 200 are disposed upstream of the cooling airflow from the radiator 300, the temperature of the cooling airflow becomes high after passing through the first and second intercoolers 100, 200, so that the cooling performance of the radiator 300 is decreased. Therefore, the first intercooler 100 is disposed downstream of the cooling airflow from the radiator 300, and the second intercooler 200 is disposed upstream from the radiator 300.

Moreover, the first intercooler 100 is disposed downstream of the cooling airflow from the radiator 300, since the temperature of the internal air flowing into the first intercooler 100 is comparatively high. Therefore, both of temperature differences between the internal air flowing in the first and second intercoolers 100, 200 and the cooling airflow are secured to become large.

In other words, the temperature of the internal air flowing in the second intercooler 200 is lower than that flowing in the first intercooler 100, and the temperature of the cooling airflow before passing through the second intercooler 200 is also lower than that before passing through the first intercooler 100. Therefore, both temperature differences are comparatively large. If the first intercooler 100 is disposed upstream from the radiator 300, and the second inter cooler 200 is disposed downstream from the radiator 300, although the temperature difference between the internal air flowing in the first intercooler 100 and the cooling airflow is much higher, the temperature difference between the internal air flowing in the second intercooler 200 and the cooling airflow is much lower. In this case, total cooling performance of cooling the internal air is decreased. Therefore, the first intercooler 100 is disposed downstream of the cooling airflow from the radiator 300.

As shown in FIG. 2, the first and second intercoolers 100, 200 have almost the same construction. Each intercooler 100, 200 includes a left tank 110, a right tank 120, and a core 130. A cross-section of each tank 110, 120 has an almost U-shape. The tank 110, 120 has an opening, which opens to the core 130, and is made of casting. One end of each tank 110, 120 has a pipe 111, 121, respectively. The pipe 111, 121 is formed integrally with the tank 110, 120.

The core 130 includes a plurality of fins 131 and a plurality of tubes 132. The fins 131 and the tubes 132 are laminated each other. A side plate 133 is disposed outside of the outermost fin 131. A pair of core plates 134 is disposed both ends of the tube 132 in a lateral direction. The fin 131, the tube 132, the side plate 133, and the core plate 134 are brazed integrally so that the core 130 is formed. An inner fin (not shown) is inserted in the tube 132. The inner fin provides to enlarge heat conduction area and to improve heat transfer by generating turbulence of the internal air passing through the tube 132.

Each opening of the tanks 110, 120 is welded to each core plate 134, respectively. Thus, the intercooler 100, 200 is formed. Then, each pipe 121 of the first and second intercoolers 100, 200 is connected together with the hose 20, so that the intercooler 10 is accomplished.

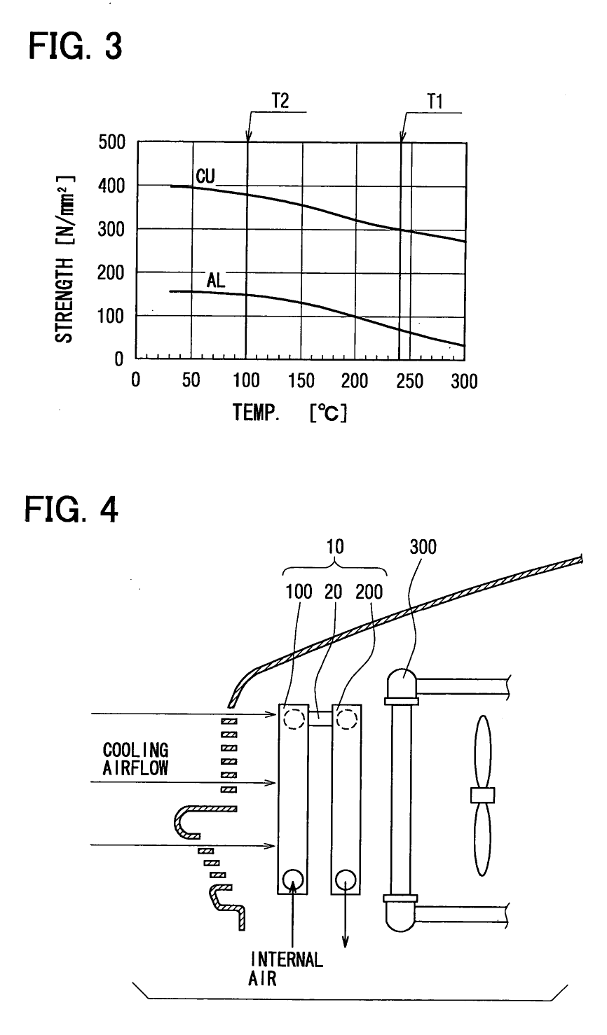

Here, material composing the first intercooler 100 is different from that composing the second intercooler 200. Specifically, the material composing the first intercooler 100 is copper or copper based material (i.e., copper material). The material composing the second intercooler 200 is aluminum or aluminum based material (i.e., aluminum material). Here, the copper material is superior to the aluminum material with regard to mechanical strength such as tensile strength against high temperature, as shown in FIG. 3.

Next, operation of the heat exchanger unit is described as follows.

The internal air is supercharged, so that the temperature of the internal air becomes high, for example, the temperature of the internal air is 240° C. in a case of high-level supercharger. The high-temperature internal air flows into the first intercooler 100, so that the internal air is cooled firstly by heat exchange between the high-temperature internal air and the cooling airflow just after passing through the radiator 300. Thus, the internal air is cooled down to, for example, about 100° C. Then, the internal air flows into the second intercooler 200, so that the internal air is cooled secondary by heat exchange between the internal air and the cooling airflow before passing through the radiator 300. Thus, the internal air is cooled down to, for example, about 50° C. finally. Then, the internal air flows into the engine.

The temperature of the air flowing into the first intercooler 100 (e.g., the temperature is 240° C. shown as T1 in FIG. 3) is comparatively high, and higher than the temperature of the air flowing into the second intercooler 200 (e.g., the temperature is 100° C. shown as T2 in FIG. 3). Therefore, if the first intercooler 100 is made of the aluminum material, sufficient mechanical strength such as tensile strength of the first intercooler 100 cannot be secured against vibration of the vehicle in a case of the vehicle running. That is, because the tensile strength of aluminum is decreased larger against high temperature compared with that of copper, as shown in FIG. 3. It is considered that plate thickness of each part, specifically, the fin 131 and the tube 132, becomes thicker for compensating the decrease of the tensile strength. However, this causes to increase flowing resistance of the cooling airflow or the internal air.

However, the heat exchanger unit according to this embodiment includes the first and second intercoolers 100, 200. Therefore, each material composing each intercooler 100, 200 can be selected individually according to each temperature of the internal air flowing into each intercooler 100, 200. Thus, the heat resistance of the intercooler 10 is improved without increasing the manufacturing cost of the intercooler 10.

Specifically, the material of the first intercooler 100 is the copper material, which is superior to the aluminum material with regard to the tensile strength. Therefore, the heat resistance of the first intercooler 100 is improved. In this case, the manufacturing cost increases by changing the material of the first intercooler 100 from the aluminum material to the copper material. However, since the tensile strength of the first intercooler 100 becomes large, each plate thickness of parts in the first intercooler 100 can be optimized according to the tensile strength of the part, so that the manufacturing is limited to increase.

Moreover, the first intercooler 100 made of the copper material is disposed downstream from the second intercooler 200 and the radiator 300. Therefore, if the copper material of the first intercooler 100 is scratched into a copper powder by fine particles such as sand contained in the cooling airflow in a case of a construction vehicle and the like, the copper powder does not adhere to the radiator 300 and the second intercooler 200, which are made of the aluminum material, because the copper powder flows downstream of the cooling airflow from the first intercooler 100. Thus, the radiator 300 and the second intercooler 200 are protected from the stray current corrosion generated by the copper powder.

(Second Embodiment)

A heat exchanger unit according to a second embodiment of the present invention is shown in FIG. 4. The first and second intercoolers are disposed upstream of the cooling airflow from the radiator 300 so as to improve the cooling performance of the intercooler 10 and the radiator 300. Moreover, the first intercooler 100 made of the copper material is disposed upstream from the second intercooler 200 made of the aluminum material.

In this case, since the temperature of the internal air flowing into the first intercooler 100 is higher than that flowing into the second intercooler 200, and the temperature of the cooling airflow before passing through the first intercooler 100 is the lowest, the internal air flowing into the first intercooler 100 is efficiently cooled.

Here, the copper material of the first intercooler 100 is scratched into a copper powder by fine particles such as sand contained in the cooling airflow, the copper powder adheres to the second intercooler 200, which is disposed downstream from the first intercooler 100. In general, the intercooler 10 is superior to the radiator with regard to the stray current corrosion, since the operation pressure of the internal fluid of the intercooler 10 is higher than that of the radiator 300 so that the plate thickness of the intercooler 10 is thicker than that of the radiator 300. Therefore, although the copper powder adheres to the second intercooler 200, it does not become problem substantially since the tensile strength of the second intercooler 200 is higher than that of the radiator 300.

Further, the second intercooler 200 works as a filter against the radiator 300, so that the copper powder does not adhere to the radiator 300 substantially. Thus, the radiator 300 is protected from the stray current corrosion generated by the copper powder.

Thus, the heat resistance of the intercooler 10 is improved without increasing the manufacturing cost of the intercooler 10.

(Modifications)

Although the intercooler 10 is used as a heat exchanger, as long as the heat exchanger unit includes the first heat exchanger and the second heat exchanger, another heat exchanger unit such as a radiator, an oil cooler, and a condenser can be used as the heat exchanger in the heat exchanger unit.

Further, although the first and second intercoolers 100, 200 are made of the copper material and the aluminum material, another material, which has excellent tensile strength against high temperature, can be used as the material composing the first and second heat exchanger. For example, the combination of stainless and the aluminum material and the combination of stainless and the copper material can be used as the material composing the heat exchanger.

Further, although the heat exchanger cools the internal fluid, the heat exchanger can heat the internal fluid. In this case, the material composing the second heat exchanger is selected such that the heat resistance of the second heat exchanger is improved, since the temperature of the second heat exchanger becomes higher.

Such changes and modifications are to be understood as being within the scope of the present invention as defined by the appended claims.

What is claimed is:

1. Heat exchanger unit comprising:
a first heat exchanger for flowing internal fluid therein and cooling the internal fluid; and
a second heat exchanger disposed downstream of the internal fluid from the first heat exchanger,
wherein the first and second heat exchangers are made of first and second materials, respectively, and
wherein the first material is different from the second material.

2. The heat exchanger unit according to claim 1,
wherein the internal fluid is cooled by the first and second heat exchangers in this order, and
wherein the first material is superior to the second material with regard to mechanical strength against high temperature.

3. The heat exchanger unit according to claim 2,
wherein the first material is copper or copper based material, and
wherein the second material is aluminum or aluminum based material.

4. The heat exchanger unit according to claim 1,
wherein the internal fluid is air for being supercharged and sucked into an engine of a vehicle, and
wherein the first and second heat exchangers are first and second intercoolers, respectively.

5. The heat exchanger unit according to claim 3,
wherein the first and second heat exchangers are disposed in a direction of external fluid for passing therethrough and cooling the internal fluid, and
wherein the first heat exchanger is disposed downstream of the external fluid from a radiator for cooling an engine of a vehicle, and disposed downstream of the external fluid from the second heat exchanger.

6. The heat exchanger unit according to claim 4,
wherein the first and second heat exchangers are disposed in a direction of external fluid for passing therethrough and cooling the internal fluid, and
wherein the first heat exchanger is disposed upstream of the external fluid from the second heat exchanger.

7. The heat exchanger unit according to claim 5,
wherein the second heat exchanger is disposed upstream of the external fluid from the radiator.

8. The heat exchanger unit according to claim 1,
wherein the first and second heat exchangers are radiators, oil coolers, or condensers.

9. The heat exchanger unit according to claim 6,
wherein the second heat exchanger is disposed upstream of the external fluid from a radiator for cooling an engine of a vehicle.

10. The heat exchanger unit according to claim 3,
wherein the temperature of the internal fluid flowing into the first heat exchanger is equal to and above 200° C., and
wherein the temperature of the internal fluid flowing into the second heat exchanger is equal to and above 50° C.
